(19) United States
(12) Patent Application Publication
(10) Pub. No.: US 2006/0065130 A1
(43) Pub. Date: Mar. 30, 2006

(54) Deep fat fryer and collar for such a fryer

(75) Inventor: Huub Ehlhardt, 's-Hertogenbosch (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,623

(22) PCT Filed: Nov. 17, 2003
(86) PCT No.: PCT/IB03/05246

§ 371 Date: Jun. 10, 2005

(30) Foreign Application Priority Data
Dec. 18, 2002 (EP) 02080359.9

(51) Int. Cl. A47J 37/12

(52) U.S. Cl. 99/404; 99/403

(57) ABSTRACT

A deep fat fryer including a pan (2) for holding liquid fat for frying food, the pan (2) having a brim (4) extending along its topmost end, a heater (7) for heating fat in the pan (2), a housing shielding the pan (2) from the environment, an upright exterior wall surface (8) facing away from the pan (2), and a collar (9) extending closely along the brim (4) of the pan (2). The collar (9) is detachable and includes a flange (11) projecting outwardly from the brim (4) and shields at least a portion of the upright exterior wall surface (8). The flange (11) counteracts soiling of upright exterior wall surface (8) and can be cleaned or disposed easily.

The invention relates to a fryer according to the introductory portion of claim 1.

Such a fryer is known from U.S. Pat. No. 6,002,111. Since the pan of this known fryer is removable from the heater and the housing, the pan can be cleaned relatively easily by hand or in an automatic dishwasher. However, in practice also the exterior of the housing of the pan becomes soiled with fat, which in turn promotes the sticking of dust and dirt to the exterior of the fryer. The cleaning of the exterior of the fryer is cumbersome, in particular because the housing is not dishwasher resistant and may not be submerged in water or be exposed to an intensive flow or spray of water emerging from a tap or a spray head. Another reason why the cleaning of the housing is cumbersome is its relatively large size and heavy weight, which complicates the handling and makes it difficult or impossible to accommodate the housing in a dishwasher. The same inconveniencies are also encountered when using a deep fat fryer of which the pan for holding the fat is not removable from the heater and the housing.

It is an object of the present invention to provide a solution that makes the removal of fat from the exterior of a deep fat frying pan less cumbersome.

According to the present invention, this object is achieved by providing a fryer according to claim 1. The invention can also be embodied in a collar according to claim 12 for such fryer. The flange of the detachable collar shields the upright exterior wall surface of the fryer, so that this surface is shielded against soiling with fat. Since the collar is detachable, it can be cleaned relatively easily or be disposed and replaced with a clean collar.

Particular embodiments of the invention are set forth in the dependent claims. Further features, effects and details of the invention appear from the detailed description in which reference is made to examples of fryers according to the invention.

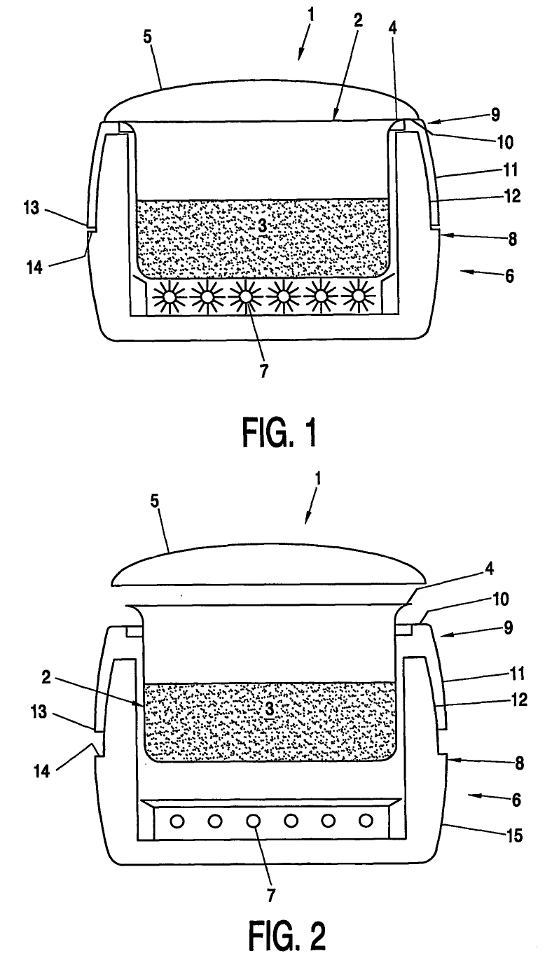

FIG. 1 a schematic cross-sectional view of a first example of a fryer and a collar according to the invention;

FIG. 2 a schematic exploded, cross-sectional view of the fryer according to FIG. 1;

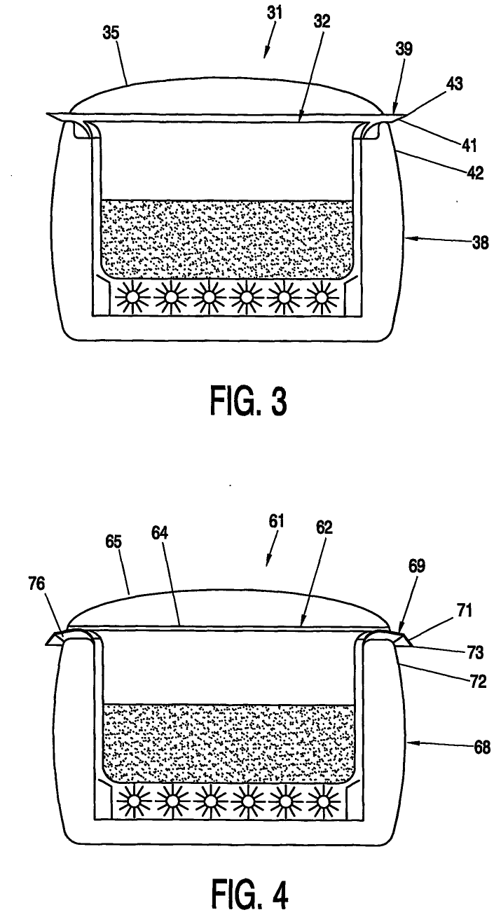

FIG. 3 a schematic cross-sectional view of a second example of a fryer and a collar according to the invention; and

FIG. 4 a schematic cross-sectional view of a third example of a fryer and a collar according to the invention.

First, the deep fat fryer 1 shown in FIGS. 1 and 2 is discussed. The fryer 1 has a pan 2 for holding liquid fat 3 for frying food. The pan 2 has a brim 4 extending along its topmost end. For closing off the pan 2, the fryer has a cover 5.

The pan 2 is arranged inside a housing 6 shielding the pan 2 from the environment to avoid the risk of direct contact of a user or other person with the pan 2 that is hot when the fryer is in use.

For heating the fat 3 in the pan 2, the fryer has a heater 7. According to this example, the heater 7 is also arranged inside the housing under the pan 2. The heater 7 according to the present example is an electric heater. Since such heaters are well known in the art, further details regarding the heater and the power supply and control circuitry are not shown. It is observed that the heater may also be integrated in the bottom and/or the wall of the pan and connected with the power supply via connectors that are disconnected when the pan is removed and reconnected when the pan is re-installed.

The fryer 1 further has an upright exterior wall surface 8 facing away from the pan 2; and a collar 9 extending closely along the brim 4 of the pan 2. According to the present example, the brim 4 and the collar 9 are circular when seen in top plan view. However, the brim 4 and the collar 9 may extend around the opening of the pan 2 according to another shape, for instance according to a generally oval, rectangular or square shape.

The collar 9 is detachable as is shown in FIG. 2 and includes a portion 10 extending closely along the brim 4 and a flange 11 projecting outwardly from the brim 4 and shielding an upper portion 12 of the upright exterior surface 8 of the fryer against fat that falls down. For instance, fat that has spirted out of the pan or fat that drips down from a frying basket or from food that has been taken out of the fat.

The flange 11 of the collar 9 catches fat that may for instance have spurted from the bath of fat 3 in the pan upon entering food therein or have dropped from a frying basket that is removed from the pan and would have soiled the upper portion 12 of the exterior surface 8 of the frying pan 1. Thus, soiling of the exterior surface counteracted. Since the collar 9 forms a relatively small and light part that can be detached from the housing 6, it can easily be cleaned, either by hand or in a machine or be disposed of it is provided in low-cost disposable form. It is observed that the flange may shield the whole exterior wall surface 8, but that usually most of the soiling occurs on the upwardly facing upper portion 12 of the exterior upright wall surface 8. in view of that consideration and to limit the size and weight of the collar 9, it is generally preferred to shield only or mainly that portion 12 of the upright exterior surface 8.

According to the present example, the flange 11 of the collar 9 shields an exterior surface portion 12 of the housing 6. Accordingly, if the collar is inadvertently detached while the pan 2 is hot or not mounted before the fryer 1 is operated, the housing 6 still shields the pan 2 from against contact with the skin of the user or of another person in the vicinity of the fryer 1. It is however also possible to provide that only the flange or the collar forms the shield between the pan 2, or a portion of the pan 2 near its top, and the environment. In that case the collar is preferably secured against inadvertent removal, at least if the pan is hot, and the heating structure is then preferably arranged to be or remain automatically switched off in absence of the collar.

According to the present example, the flange 11 projects downwardly along the exterior upright wall surface 8. Accordingly a very effective shielding of the wall against soiling with fat is obtained. The flange 11 not only shields the exterior wall surface behind it against fat spurting out of the pan or dropping from a frying basket, but also against indirect soiling caused by fatty fingers and the like. Furthermore, the flange 11 projects over a relatively small distance in radial direction, so that it occupies little or no additional horizontal area.

Furthermore, a free edge 13 of the flange 11 abuts or extends closely along the exterior surface 8 of the upright wall. This design makes it difficult to lift the fryer by the free edge 13 of the flange 11 which would cause the connection between the collar 9 and the housing 6 to be loaded relatively heavily. Furthermore, it is thus avoided that body parts and objects get clamped between the flange 11 and the housing 6.

The exterior of the upright wall surface 8 has a rim 14 having an upwardly facing surface at a distance below a top end of the housing 6 and extending around the housing 6. The free edge 13 of the flange 11 abuts or extends closely along this rim 14. This further reduces the likelihood of objects and body part being inserted between the flange 11 and the exterior surface 12 shielded thereby.

The shielded portion 12 of the exterior of the wall surface 8 along which the flange 11 extends is inwardly recessed relative to a portion 15 of the upright wall surface 8 located under the recessed wall portion 12. This further contributes to the compactness of the collar 9 and its flange 11. More in particular, the flange 11 and the recessed wall portion 12 form a double thermal shielding in the topmost area of the housing where the temperature inside the housing is highest when the fryer 1 is in use. Accordingly, the wall 12 can be recessed for maintaining compactness of the housing 6 without causing an increase of the temperature of the surfaces accessible from the outside due to the additional thermal shielding provided by the flange 11.

For further facilitating the cleaning of the flange 11, it is advantageous if the flange 11 has an anti-adhesive outer surface, for instance of PTFE or sol-gel material.

In FIGS. 3 and 4 examples of fryers 31, 61 according to the invention are shown of which the collars 39, 69 each have a flange 41, 71 that projects away from the exterior upright wall surface 38, 68 of which an upper portion 42, 72 is shielded by the flange 41 71. Free edges 43, 73 of the flanges 41, 71 are spaced from the exterior wall surface 38, 68. The flanges 41, 71 of these fryers 31, 61 do not shield the portions 42, 72 of the exterior surface of the fryer against soiling by essentially covering these surface portions 42, 72, but by forming an eaves that causes most of the fat dropping in the area of the wall surface 38, 68 to be either caught by the flange 41, 71 or to stay clear from the shielded portions 42, 72 of the wall surface 8. An advantage of a collar 39 69 with such a flange 41, 71 is that the collar is very compact, so that it is even more easy to clean or causes relatively little waste if it is disposed.

Furthermore, due to the relatively small size of the flange 41, 71 that is sufficient for obtaining the desired protection, the material of the collar 39, 69 does not need to be particularly stiff or strong. This in turn, makes the collar 39, 69 particularly suitable to be made of flexible material, such as heat resistant rubber. This further facilitates cleaning, reduces the risk of damaging the detached collar and allows the collar to be integrated with the collar forming a seal between the pan 32, 62 and the cover 35, 65.

The relatively low stiffness and strength requirements further make these collars 39, 69 particularly suitable to be manufactured at least partially of fat absorbing material, such as paper or cardboard. By manufacturing at least the flange 41, 71 of the collar of such fat absorbing material indirect soiling of objects such as clothing touching the flange is at least reduced.

Furthermore, the relatively low stiffness and strength requirements make these collars 39, 69 particularly suitable to be manufactured at least partially of biodegradable material, such as paper, cardboard or starch based polymers. This in turn allows to provide the collars 39, 69 or at least the flanges 41, 71 thereof as disposable items, without increasing the volume of more or less non-degradable waste.

The flange 41 of the collar 39 of the fryer according to FIG. 3 extends upwardly. This provides the advantage that fat that is collected on the flange 41 does not flow outwardly where it could drip down from the flange 41 or could easily soil clothing or other objects touching the peripheral edge 43 of the flange 11, but inwardly where it may for instance be collected in gutter.

The flange 71 of the fryer 61 shown in FIG. 4 has web-shaped supports 76 under the flange 71. Furthermore, the flange 71 extends downwards from the part of the collar 69 extending along the brim 64, with is advantageous for effective shielding of the portion 72 of the wall at a relatively small horizontal dimensions.

The collars 9, 39, 69 can also be supplied as separate spare or disposable or parts. In particular if the collar is supplied as a disposable product, it is advantageous to supply a plurality of collars in a package. The collars are preferably designed specifically for a particular fryer. However, in particular if the collar is of a flexible, elastic material, such as for instance heat resistant rubber, an elastic collar can for instance be suitable for use on fryers of different designs.

It will be clear from the foregoing that the described examples form non-limiting illustrations and it will be clear that many other examples are conceivable within the framework of the present invention. For instance, the heater may for instance be provided in the form of an element that is submerged in the fat in the pan and grips for gripping the pan may for instance be integrated in the collar, arranged under the collar or extend through cut-outs in the collar.

1. A deep fat fryer comprising:
a pan for holding liquid fat for frying food, the pan having a brim extending along its topmost end;
a heater for heating fat in the pan;
a housing shielding the pan from the environment;
an upright exterior wall surface facing away from the pan; and
a collar extending closely along the brim of the pan; characterized in that the collar is detachable and includes a flange projecting outwardly from the brim.

2. A fryer according to claim 1, wherein the flange projects downwardly along at least a portion of said wall surface.

3. A fryer according to claim 2, wherein a free edge of the flange abuts or extends closely along said wall surface.

4. A fryer according to claim 3, wherein said wall surface has a rim having an upwardly facing surface extending around said housing, said free edge of said flange abutting or extending closely along said rim.

5. A fryer according to claim 2, wherein said portion of said wall surface along which said flange extends is inwardly recessed relative to a portion of said wall surface located under said recessed wall portion.

6. A fryer according to claim 1, wherein said flange projects away from said wall surface, a free edge of said flange being radially and outwardly spaced from said wall surface.

7. A fryer according to claim 6, wherein said flange extends upwardly.

8. A fryer according to claim 1, wherein the flange has an anti-adhesive outer surface.

9. A fryer according to claim 1, wherein at least a portion of the collar is of a flexible material.

10. A fryer according to claim 1, wherein at least said flange is of fat absorbing material.

11. A fryer according to claim 1, wherein at least said flange is of biodegradable material.

12. A collar for mounting in a position extending along a brim of a liquid fat holding pan of a fryer according to claim 1, the brim extending along a topmost end of the pan, the fryer further comprising a housing shielding the pan from the environment, and an upright exterior wall surface facing away from the pan; the collar having at least one portion for mounting closely along said brim; the collar including a flange projecting outwardly from the portion for mounting closely along said brim.
